(19) United States
(12) Patent Application Publication
(10) Pub. No.: US 2021/0337841 A1
(43) Pub. Date: Nov. 4, 2021

(54) LEGUME PROCESSING AND LEGUME FOOD PRODUCTS

(71) Applicant: BEANITOS INC., Austin, TX (US)

(72) Inventor: Rusty L. Karschner, Madeira Beach, FL (US)

(21) Appl. No.: 17/295,871

(22) PCT Filed: Oct. 21, 2019
(86) PCT No.: PCT/US2019/057200

§ 371 Date: May 20, 2021

Related U.S. Application Data
(60) Provisional application No. 62/750,068, filed on Oct. 24, 2018.

(51) Int. Cl. A23L 11/10; A23L 11/30

(52) U.S. Cl. CPC A23L 11/10; A23L 11/33; A23L 11/31

(57) ABSTRACT

Treating fresh legumes includes combining fresh legumes with water to yield a mixture, heating the mixture from an initial temperature to a cooking temperature to yield a pre-cooked mixture, and heating the pre-cooked mixture at the cooking temperature to yield a cooked mixture. The cooked mixture is cooled to yield a cooled mixture, and water is removed from the cooled mixture to yield cooked legumes having an average moisture content in a range of 50 wt % to 65 wt %. A legume dough, prepared from the cooked legumes, can be sheeted and formed into legume dough pieces. The legume dough pieces may be cooked to yield a cooked legume dough product. In one example, the cooked legume dough product is a snack chip.

### CROSS-REFERENCE TO RELATED APPLICATIONS

The present application is a national stage application, filed under 35 U.S.C. § 371, of International Application No. PCT/US2019/057200 for “Legume Processing and Legume Food Products”, filed on Oct. 21, 2019, which is incorporated by reference herein in its entirety.

International Application No. PCT/US2019/057200 claims the benefit of U.S. Provisional Application Ser. No. 62/750,068 for “Legume Processing and Legume Food Products”, filed on Oct. 24, 2018, which is incorporated by reference herein in its entirety.

### TECHNICAL FIELD

This invention relates to processing of fresh legumes and legume food products prepared from the fresh legumes.

### BACKGROUND

Legume food products, such as snack chips, are typically prepared from dehydrated legumes in a process that includes rehydrating the dehydrated legume particles (e.g., “grits”) into a paste. The paste can be formed into a de-sired thickness and shape and then cooked. However, the legume paste can be difficult to manipulate, and the resulting legume food products can have a taste that differs from fresh legumes.

### SUMMARY

In a first general aspect, treating fresh legumes includes combining fresh legumes with water to yield a mixture, and heating the mixture from an initial temperature (less than 100° F.) to a cooking temperature (in a range of 180° F. to 205° F.) to yield a pre-cooked mixture. The pre-cooked mixture is heated at the cooking temperature to yield a cooked mixture. The cooked mixture is cooled to yield a cooled mixture (170° F. or less). Water is removed from the cooled mixture to yield cooked legumes having an average moisture content in a range of 50 wt % to 65 wt %.

Implementations of the first general aspect may include one or more of the following features.

The fresh legumes may be whole, split, or further reduced in size. The fresh legumes may be selected from the group consisting of chickpeas, beans, peas, lentils, and lupins. Suitable beans include adzuki beans, black beans, borlotti beans, cannellini beans, faba beans, great northern beans, lima beans, mung beans, navy beans, pinto beans, kidney beans, soybeans, heirloom beans, and any combination thereof. The fresh legumes may have an average moisture content in a range of 8 wt % to 10 wt %.

The cooking temperature is typically in a range of 195° F. to 205° F. The average moisture content of the cooked legumes can be in a range of 60 wt % to 65 wt %. The mixture can have a pH in a range of 6 to 7.

In some cases, an additive is combined with the legume dough to yield a modified legume dough. The additive may include rice flour, wheat flour, corn flour, tapioca starch, or any combination thereof. In certain cases, the additive includes a glycoside hydrolase (e.g., alpha-galactosidase). A weight ratio of the glycoside hydrolase to the fresh legumes is in a range of 0.001:1 to 0.006:1.

Heating the mixture from the initial temperature to the cooking temperature can occur in 16 minutes to 20 minutes. Heating the pre-cooked mixture at the cooking temperature may include heating the pre-cooked mixture for 4 minutes to 12 minutes at the cooking temperature to yield the cooked mixture. Heating the pre-cooked mixture at the cooking temperature may include heating the pre-cooked mixture for 8 minutes to 12 minutes at the cooking temperature to yield the cooked mixture. Heating the pre-cooked mixture at the cooking temperature usually includes heating within ±1° F. of the cooking temperature.

Cooling the cooked mixture to yield the cooled mixture typically occurs in 5 minutes or less. Cooling the cooked mixture may include adding water to the cooked mixture. The cooled mixture typically has a temperature in a range of 150° F. to 170° F. Cooling the cooked mixture includes allowing the cooled mixture to reach thermal equilibrium.

In some cases, at least 50 wt % (e.g., at least 70 wt %, at least 80 wt %, or at least 90 wt %) of the cooked legumes are whole. Heating the pre-cooked mixture may include separating a plurality of legume skins from the legumes. The cooled mixture may include the plurality of legume skins, and removing the water from the cooled mixture may include removing the legume skins from the cooled mixture. The legume skins may be combined with the cooked legumes to yield a cooked legume mixture.

A content of indigestible sugars in the cooked legumes is at least 10 wt %, at least 20 wt %, at least 30 wt %, or at least 50 wt % less than the content of indigestible sugars in the fresh legumes. The indigestible sugars may include one or more of raffinose, verbascose, and stachyose.

The cooked legumes may be cut to yield cut legume particles. Cutting the cooked legumes typically includes contacting the cooked legumes with a plurality of blades. A particle size of the cut legume particles is in a range of 0.03 inches to 0.06 inches.

Water may be combined with the cut legume particles to yield a legume dough. The legume dough is sheetable. The legume dough typically has a moisture content in a range of 50 wt % to 70 wt % or 60 wt % to 70 wt %. A leg-TGB001-5 ume dough sheet having a uniform thickness may be formed from the legume dough. The legume dough sheet may be cut into a plurality of legume dough pieces. The legume dough pieces are typically cooked (e.g., baked or fried) to yield a cooked legume dough product.

A protein content of the cooked legume dough product is typically in a range of 15 wt % to 40 wt % (e.g., 15 wt % to 30 wt %, or 15 wt % to 20 wt %). A content of indigestible sugars in the cooked legume dough product is at least 10 wt %, at least 20 wt %, at least 30 wt %, or at least 50 wt % less than the content of indigestible sugars in the fresh legumes.

In a second general aspect, a legume dough may be prepared by combining fresh legumes having a moisture content in a range of 8 wt % to 10 wt % with water to yield a mixture, heating the mixture from an initial temperature of less than 100° F. to a cooking temperature in a range of 195° F. to 205° F. to yield a pre-cooked mixture, and heating the pre-cooked mixture at the cooking temperature to yield a cooked mixture. The cooked mixture may be cooled to a temperature of 170° F. or less to yield a cooled mixture. The water may be removed from the cooled mixture to yield cooked legumes having a moisture content in a range of 50 wt % to 65 wt %. The cooked legumes are cut (e.g., with a steel blade) to yield cut legume particles, and water is combined with the cut legume particles to yield a legume dough.

Implementations of the second general aspect may include one or more of the following features.

The fresh legumes may be whole, split, or further reduced in size. The legume dough typically has a moisture content in a range of 50 wt % to 70 wt % (e.g., 60 wt % to 70 wt %).

A third general aspect includes a cooked legume dough product prepared by combining fresh legumes having a moisture content in a range of 8 wt % to 10 wt % with water to yield a mixture, heating the mixture from an initial temperature of less than 100° F. to a cooking temperature in a range of 195° F. to 205° F. to yield a pre-cooked mixture, and heating the pre-cooked mixture at the cooking temperature to yield a cooked mixture. The cooked mixture is cooled to a temperature of 170° F. or less to yield a cooled mixture, and water is removed from the cooled mixture to yield cooked legumes having a moisture content in a range of 50 wt % to 65 wt %. The cooked legumes are cut to yield cut legume particles, and water is combined with the cut legume particles to yield a legume dough. A legume dough sheet having a uniform thickness is formed from the legume dough. The legume dough sheet is cut into a plurality of legume dough pieces, and the legume dough pieces are cooked to yield a cooked legume dough product.

Implementations of the third general aspect may include one or more of the following features.

Cooking the legume dough pieces typically includes baking or frying the legume dough pieces. A protein content of the cooked legume dough product is typically in a range of 15 wt % to 40 wt %. A content of indigestible sugars in the cooked legume dough product is typically at least 10 wt %, at least 20 wt %, at least 30 wt %, or at least 50 wt % less than the content of indigestible sugars in the fresh legumes.

In a fourth general aspect, a legume dough includes cut legume particles having a moisture content of 50 wt % to 65 wt %. A moisture content of the legume dough is in a range of 50 wt % to 70 wt %.

Implementations of the fourth general aspect may include one or more of the following features.

A protein content of the legume dough is typically in a range of 15 wt % to 30 wt % or 15 wt % to 20 wt %. A content of indigestible sugars in the legume dough is at least 10 wt %, at least 20 wt %, at least 30 wt %, or at least 50 wt % less than the content of indigestible sugars in the fresh legumes. The cut legume particles are formed from fresh legumes, and the legume dough is in the form of a substantially uniform sheet.

In a fifth general aspect, a cooked legume dough product includes legume particles cut from fresh legumes and an additive. The protein content of the cooked legume dough product is in a range of 15 wt % to 40 wt %, and a content of indigestible sugars in the legume particles is at least 25 wt % less than the content of indigestible sugars in the fresh legumes.

Implementations of the fifth general aspect may include one or more of the following features.

The additive may include rice flour, wheat flour, corn flour, tapioca starch, or any combination thereof. The cooked legume dough product may include 20 wt % to 30 wt % of the additive. The cooked legume dough product includes 70 wt % to 80 wt % of the cut legume particles.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow chart depicting a process for preparing a legume food product.

FIG. 2 is a block diagram depicting components in a production line for processing fresh legumes.

### DETAILED DESCRIPTION

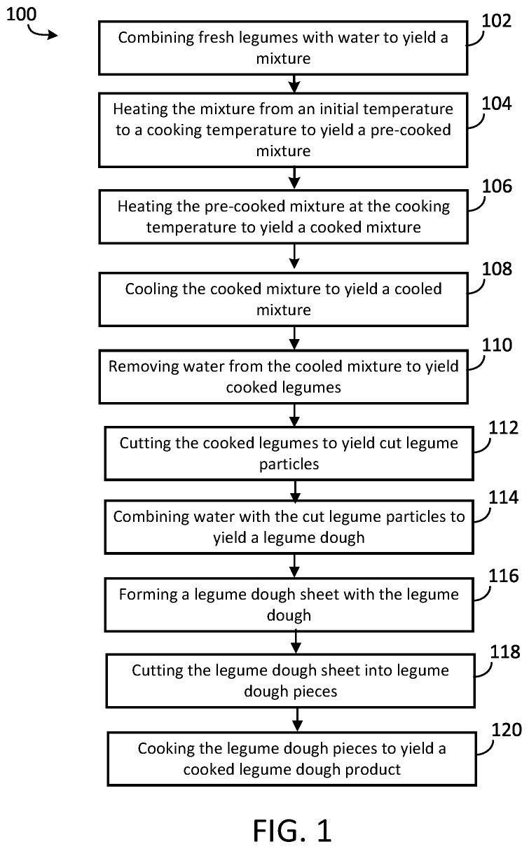

FIG. 1 depicts process 100 for preparing a legume food product from fresh legumes. “Legume” refers to the fruit or seed of a legume plant, and may include one or more of chickpeas, beans, peas, lentils, and lupins. Suitable beans include adzuki beans, black beans, borlotti beans, cannellini beans, faba beans, great northern beans, lima beans, mung beans, navy beans, pinto beans, kidney beans, soybeans, and heirloom beans. The fresh legumes may be whole fresh legumes, split fresh legumes, or fresh legumes in any other configuration (e.g., broken or cut). A “whole” legume refers to a legume that is in a substantially unbroken or undamaged state, with the skin intact, where any missing por-tions of the legume account for less than 90 wt % of the legume. A “split” legume refers to a half of a legume (i.e., a legume split into cotyledons). “Fresh” legumes refer to legumes that have been removed from pods or shells and cleaned, but have not been cooked (i.e., raw legumes) or dehydrated. Fresh legumes may be whole, split, or further reduced in size (e.g., by breakage or other means). In some cases, fresh legumes have not been skinned, cut, ground, or any combination thereof. The fresh legumes typically have an average moisture content in a range of 8 wt % to 10 wt %. Process 100 is typically a batch process. The legume food product is suitable for human consumption. Examples of legume food products that can be prepared by process 100 include cut legume particles, legume dough, and legume chips (e.g., snack chips prepared from the legume dough).

In 102, fresh legumes are combined with water to yield a mixture. The fresh legumes may be whole, split, or further reduced in size. The water may be tap water at ambient temperature. The mixture may include one or more additives. Examples of suitable additives include hydrated lime and sodium chloride. Hydrated lime, sodium chloride, or both may be included up to about 1 wt % of the legumes. In some cases, a glycoside hydrolase is combined with the mixture. When a glycoside hydrolase is combined with the mixture, a pH of the mixture is typically in a range of 6 to 7. An example of a suitable glycoside hydrolase is alpha-galactosidase. The glycoside hydrolase may be present in a range of 0.1 wt % to 0.6 wt % of the legumes. The glycoside hydrolase assists in hydrolysis of glycosidic bonds in complex (indigestible) sugars such as trisaccha-rides, tetrasaccharides, and pentasaccharides, examples of which include raffinose, stachyose, and verbascose, respectively. Including a glycoside hydrolase in the mixture reduces the content of indigestible sugars in legume food products formed from the mixture.

In 104, the mixture is heated from an initial temperature to a cooking temperature to yield a pre-cooked mixture. The initial temperature is typically less than 100° F. (e.g., 80° F.) and the cooking temperature is typically in a range of 180° F. to 205° F. Heating the mixture above 140° F. typically inactivates any glycoside hydrolase in the mixture, such that the pre-cooked mixture is substantially free of active enzyme. In some cases, the cooking temperature is in a range of 195° F. to 205° F. Heating the mixture from the initial temperature to the cooking temperature to yield the pre-cooked mixture occurs in 16 minutes to 20 minutes. In some cases, heating the mixture from the initial temperature to the cooking temperature in less than about 16 minutes causes the legumes to break apart before the cooking temperature is reached.

In 106, the pre-cooked mixture is heated at the cooking temperature to yield a cooked mixture. The pre-cooked mixture is heated at the cooking temperature for 4 minutes to 12 minutes (e.g., 8 minutes to 12 minutes). Heating the pre-cooked mixture at the cooking temperature typically includes heating the pre-cooked mixture within ±1° F. of the cooking temperature. Heating the pre-cooked mixture at the cooking temperature allows the legumes to absorb moisture while gelatinizing starch and denaturing protein in the legumes. In some cases, heating of the pre-cooked mixture results in separation of skins from some of the legumes.

In 108, the cooked mixture is cooled to yield a cooled mixture.

Cooling the cooked mixture may be achieved by combining water having a temperature less than that of the cooking temperature with the cooked mixture to reduce a temperature of the cooked mixture, thereby arresting the cooking process. Water combined with the cooked mixture may be tap water at an ambient temperature. The cooked mixture is typically cooled sufficiently to decrease a temperature of the cooked mixture to 170° F. or less (e.g., in a range of 150° F. to 170° F.). Cooling the cooked mixture to yield the cooled mixture typically occurs in 5 minutes or less, and typically results in the cooled mixture reaching thermal equilibrium. The cooled mixture may include legume skins separated from the legumes during heating of the pre-cooked mixture.

In 110, water is removed from the cooled mixture to yield cooked legumes. Water removed from the cooled mixture may include legume skins separated from the legumes during heating. The cooked legumes have an average moisture content in a range of 50 wt % to 65 wt (e.g., 50 wt % to 60 wt %, 55 wt % to 60 wt %, 55 wt % to 65 wt %, or 65 wt % to 70 wt %). In some cases, at least 50 wt % of the cooked legumes are whole. In certain cases, at least 60 wt %, at least 70 wt %, at least 80 wt % or at least 90 wt % of the cooked legumes are whole. In some cases (e.g., when a glycoside hydrolase has been combined with the mixture), a content of indigestible sugars in the cooked legumes is at least 50 wt % less than the content of indigestible sugars in the fresh legumes. In some cases, legume skins are recovered from the water removed from the cooled mixture, and combined with the cooked legumes to yield a cooked legume mixture. The water removed from the cooled mixture may be used to cook fresh legumes in a subsequent process.

In 112, the cooked legumes (or cooked legume mixture) are cut to yield cut legume particles, where “cut” refers to reducing a size of the cooked legumes by contacting the cooked legumes with a plurality of metal blades. A moisture content of the cut legume particles is in a range of 50 wt % to 65 wt % (e.g., 50 wt % to 60 wt %, 55 wt % to 60 wt %, 55 wt % to 65 wt %, or 65 wt % to 70 wt %). At least 50 wt % of the cut legume particles have a particle size with a largest dimension in a range of 0.03 inches to 0.06 inches. In some cases, at least 60 wt %, at least 70 wt %, at least 80 wt %, or at least 90 wt % of the cut legume particles have a particle size with a largest dimension in a range of 0.03 inches to 0.06 inches. Cutting the legumes to yield cut legume particles does not include grinding or mashing the legumes.

In 114, water is combined with the cut legume particles to yield a legume dough. The water may be tap water at ambient temperature. Combining the water with the cut legume particles may include mixing the water and the cut legume particles to achieve a substantially uniform mixture. The legume dough typically has a moisture content in a range of 50 wt % to 70 wt % (e.g., 55 wt % to 70 wt %, 60 wt % to 70 wt %, 65 wt % to 70 wt %, 55 wt % to 65 wt %, 55 wt % to 60 wt %, or 65 wt % to 70 wt %). In some cases, an additive is combined with the legume dough to yield a modified legume dough. Suitable additives include starches or flours, such as rice flour, wheat flour, corn flour, tapioca starch, or any combination thereof. A protein content of the legume dough is in a range of 15 wt % to 40 wt % (e.g., 15 wt % to 30 wt %, or 15 wt % to 20 wt %). In some cases, a content of indigestible sugars in the legume dough is at least 10 wt %, at least 20 wt %, at least 25 wt %, at least 30 wt %, or at least 50 wt % less than the content of indigestible sugars in the fresh legumes. The legume dough is “sheetable,” and can be formed into a smooth sheet of dough.

In 116, a legume dough sheet is formed from the legume dough, for example, by compressing the dough between two or more rotating rollers. In one example, the dough is passed through a pre-sheeter with a gap between rollers of about 0.25 inches to about 0.75 inches (e.g., about 0.5 inches), and the pre-sheeted dough from the pre-sheeter is passed through a sheeter with a gap between rollers of about 0.02 inches to about 0.08 inches (e.g., about 0.03 inches to about 0.06 inches). The legume dough sheet typically has a thickness between about 0.02 inches and 0.08 inches (e.g., about 0.03 inches to about 0.06 inches) and an elasticity such that the legume dough sheet is smooth and consistent. The legume dough sheet is uniform in thickness and substantially free of openings having a dimension exceeding 0.03 inches. As used herein, “uniform in thickness” generally refers to a range in thickness across the sheet of less than 0.05 inches, less than 0.04 inches, or less than 0.03 inches.

In 118, the legume dough sheet may be cut into legume dough pieces. The legume dough pieces may be of any appropriate size and shape for human consumption. In some examples, the legume dough pieces are cut into circles, circular sectors, ovals, triangles, rectangles (e.g., squares), parallellograms (e.g., diamonds), or other regular or irregular shapes. Examples of suitable sizes include circles having a radius of about 3 inches, circular sectors having a radius of about 3 inches, and equilateral triangles having a side of about 3 inches.

In 120, the legume dough pieces are cooked to yield a cooked legume dough product. Cooking may include baking, frying, or both to yield a crisp cooked legume dough product. The cooked legume dough product typically includes 70 wt % to 80 wt % of cut legume particles. A protein content of the cooked legume dough product is in a range of 15 wt % to 40 wt % (e.g., 15 wt % to 30 wt %, or 15 wt % to 20 wt %). A content of indigestible sugars in the cooked legume dough product can be at least 10 wt %, at least 20 wt %, at least 30 wt %, or at least 50 wt % less than the content of indigestible sugars in the fresh legumes. The cooked legume dough product may include 10 wt % to 30 wt % (e.g., 15 wt % to 25 wt %) of an additive, such as a starch or a flour (e.g., rice flour, wheat flour, corn flour, tapioca starch, or any combination thereof).

In some cases, one or more of the operations in FIG. 1 may be omitted. That is, one or more of the operations in FIG. 1 may be optional. In some examples, 114, 116, 118, and 120, or any combination thereof, may be omitted. In certain cases, one or more of the operations depicted in FIG. 1 is replaced or combined with another operation, the order of one or more the operations is in-terchanged, two or more operations occur simultaneously or continuously, an additional operation is added, or any combination thereof.

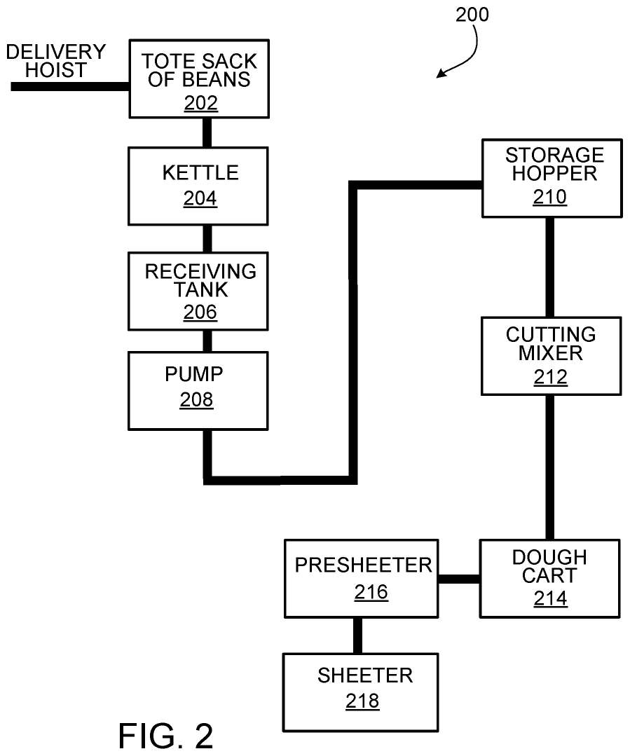

FIG. 2 is a block diagram depicting production line 200 for processing fresh legumes. Numerals in parentheses refer to the corresponding operations in process 100 of FIG. 1. In some instances, fresh legumes are delivered to production line 200 in a tote sack 202 by a delivery hoist or other method (e.g., rail car or truck load). Legumes in tote sack 202 are added to kettle 204 and combined with water to yield a mixture (102). Kettle 204 is typically a steam jacketed kettle (e.g., available from Hamilton). An agitator in kettle 204 agitates the mixture in the kettle. The mixture is heated from an initial temperature to a cooking temperature to yield a pre-cooked mixture (104), and the pre-cooked mixture is heated at the cooking temperature to yield a cooked mixture (106). The cooked mixture is cooled by addition of water to kettle 204 to yield a cooled mixture (108). The cooled mixture is transferred from kettle 204 to receiving tank 206 (e.g., available from Hamilton), and pump 208 (e.g., available from Waka-sha) removes water from the cooled mixture to yield cooked legumes (110). The cooked legumes are provided to storage hopper 210 (e.g., available from Bal-anced Mechanical). From storage hopper 210, the legumes are provided to cutting mixer 212 (e.g., available from Stephan), which has sharp metal blades and a mixing bar. Cutting mixer 212 cuts cooked legumes to yield cut legume particles (112). A dwell time of the cooked legumes in cutting mixer 212 is in a range of about 1 minute to about 5 minutes. The cut legume particles are transferred from cutting mixture 212 to dough cart 214 (e.g., available from J.C. Ford). Water is combined with the cut legume particles and mixed to yield a uniform legume dough (114). The legume dough is fed to pre-sheeter 216 (e.g., available from J.C. Ford) and then sheeter 218 (e.g., available from J.C. Ford) to form a legume dough sheet (116). The legume dough sheet is cut into legume dough pieces (118). The legume dough pieces are cooked to yield a cooked legume dough product (120).

### Example

In at least one embodiment, approximately 200 gallons of tap water (80° F.) and approximately 600 pounds of beans (black, pinto, great northern) are combined in a jacketed steam kettle. Approximately 6 pounds of hydrated lime are added to the steam kettle. The steam is turned on and agitation is initiated. After about 16 to 20 minutes, the temperature in the steam kettle reaches approximately 200° F., and the steam is turned off. Contents of the kettle are held at about 200° F. for about 8 to 10 minutes. Cooling water is added to the kettle, and the temperature of the contents of the kettle drops to approximately 145° F., arresting the cooking process. The contents of the kettle are agitated for 5 minutes to achieve thermal equilibrium, after which the contents of the kettle are transferred to a receiving tank. The contents of the receiving tank are then provided to a dewatering device and into a hopper. From the hopper, the cooked legumes are provided to a milling mixer to yield cut legume particles.

Only a few implementations are described and illustrated. Varia-tions, enhancements, and improvements of the described implementations and other implementations can be made based on what is described and illustrated in this document.

1. A method of treating fresh legumes, the method comprising:
combining fresh legumes with water to yield an initial mixture;
heating the initial mixture from an initial temperature to a cooking temperature to yield a pre-cooked mixture;
heating the pre-cooked mixture at the cooking temperature to yield a cooked mixture;
cooling the cooked mixture to yield a cooled mixture; and
removing water from the cooled mixture to yield cooked legumes.

2. The method of claim 1, wherein the fresh legumes have an average moisture content in a range of 8 wt % to 10 wt %.

3. The method of claim 1, wherein the cooking temperature is in a range of 195° F. to 205° F.

4. The method of claim 1, wherein the cooked legumes have an average moisture content.

5. The method of claim 1, wherein the mixture has a pH in a range of 6 to 7.

6. The method of claim 1, further comprising combining a glycoside hydrolase enzyme with the mixture.

7. The method of claim 6, wherein the glycoside hydrolase enzyme comprises alpha-galactosidase.

8. The method of claim 6, wherein a weight ratio of the glycoside hydrolase to the fresh legumes is in a range of 0.001:1 to 0.006:1.

9. The method of claim 1, wherein heating the mixture from the initial temperature to the cooking temperature occurs in 16 minutes to 20 minutes.

10. The method of claim 1, wherein heating the pre-cooked mixture at the cooking temperature comprises heating the pre-cooked mixture for 4 minutes to 12 minutes at the cooking temperature to yield the cooked mixture.

11. The method of claim 10, wherein heating the pre-cooked mixture at the cooking temperature comprises heating the pre-cooked mixture for 8 minutes to 12 minutes at the cooking temperature to yield the cooked mixture.

12. The method of claim 1, wherein cooling the cooked mixture to yield the cooled mixture occurs in 5 minutes or less.

13. The method of claim 1, wherein heating the pre-cooked mixture at the cooking temperature comprises heating within ±1° F. of the cooking temperature.

14. The method of claim 1, wherein cooling the cooked mixture comprises adding water to the cooked mixture.

15. The method of claim 1, wherein the cooled mixture has a temperature in a range of 150° F. to 170° F.

16. The method of claim 1, wherein cooling the cooked mixture comprises allowing the cooled mixture to reach thermal equilibrium.

17. The method of claim 1, wherein at least 50 wt % of the cooked legumes are whole.

18. The method of claim 1, wherein at least 70 wt % of the cooked legumes are whole.

19. The method of claim 1, wherein heating the pre-cooked mixture comprises separating a plurality of legume skins from the legumes.

20. The method of claim 19, wherein:
the cooled mixture comprises the plurality of legume skins; and
removing the water from the cooled mixture comprises removing the legume skins from the cooled mixture.

21. The method of claim 20, further comprising combining the legume skins with the cooked legumes to yield a cooked legume mixture.

22. The method of claim 1, wherein a content of indigestible sugars in the cooked legumes is at least 10 wt % less than a content of indigestible sugars in the fresh legumes.

23. The method of claim 22, wherein the indigestible sugars comprise at least one of the group consisting of raffinose, verbascose, and stachyose.

24. The method of claim 1, further comprising cutting the cooked legumes to yield cut legume particles.

25. The method of claim 24, wherein cutting the cooked legumes comprises contacting the cooked legumes with a plurality of blades.

26. The method of claim 25, wherein a particle size of the cut legume particles is in a range of 0.03 inches to 0.06 inches.

27. The method of claim 24, further comprising combining water with the cut legume particles to yield a legume dough.

28. The method of claim 27, wherein the legume dough is sheetable.

29. The method of claim 27, wherein the legume dough has a moisture content in a range of 50 wt % to 70 wt %.

30. The method of claim 27, further comprising combining an additive with the legume dough to yield a modified legume dough.

31. The method of claim 30, wherein the additive comprises at least one selected from the group consisting of:
rice flour;
wheat flour;
corn flour; and
tapioca starch.

32. The method of claim 27, further comprising forming a legume dough sheet from the legume dough, wherein the legume dough sheet has a substantially uniform thickness.

33. The method of claim 32, further comprising cutting the legume dough sheet into a plurality of legume dough pieces.

34. The method claim 33, further comprising cooking the legume dough pieces to yield a cooked legume dough product.

35. The method of claim 34, wherein cooking the legume dough pieces comprises at least one selected from the group consisting of:
baking the legume dough pieces; and
frying the legume dough pieces.

36. The method of claim 34, wherein a protein content of the cooked legume dough product is in a range of 15 wt % to 40 wt %.

37. The method of claim 34, wherein a protein content of the cooked legume dough product is in a range of 15 wt % to 30 wt %.

38. The method of claim 34, wherein a content of indigestible sugars in the cooked legume dough product is at least 10 wt % less than a content of indigestible sugars in the fresh legumes.

39. The method of claim 1, wherein the fresh legumes are selected from the group consisting of chickpeas, beans, peas, lentils, and lupins.

40. The method of claim 39, wherein the fresh legumes comprise beans, selected from the group consisting of adzuki beans, black beans, borlotti beans, cannellini beans, faba beans, great northern beans, lima beans, mung beans, navy beans, pinto beans, kidney beans, soybeans, and heirloom beans.

41. A legume dough prepared by a method comprising:
combining fresh legumes with water to yield an initial mixture;
heating the mixture from an initial temperature to a cooking temperature to yield a pre-cooked mixture;
heating the pre-cooked mixture at the cooking temperature to yield a cooked mixture;
cooling the cooked mixture to yield a cooled mixture;
removing water from the cooled mixture to yield cooked legumes;
cutting the cooked legumes to yield cut legume particles; and
combining water with the cut legume particles to yield a legume dough.

42. The legume dough of claim 41, wherein the legume dough has a moisture content in a range of 50 wt % to 70 wt %.

43. The legume dough of claim 41, wherein the legume dough has a moisture content in a range of 60 wt % to 70 wt %.

44. A cooked legume dough product prepared by the method comprising:
combining fresh legumes with water to yield an initial mixture;
heating the initial mixture from an initial temperature to a cooking temperature to yield a pre-cooked mixture;
heating the pre-cooked mixture at the cooking temperature to yield a cooked mixture;
cooling the cooked mixture to yield a cooled mixture;
removing water from the cooled mixture to yield cooked legumes;
cutting the cooked legumes to yield cut legume particles;
combining water with the cut legume particles to yield a legume dough;
forming a legume dough sheet from the legume dough, wherein the legume dough sheet has a uniform thickness;
cutting the legume dough sheet into a plurality of legume dough pieces; and
cooking the legume dough pieces to yield a cooked legume dough product.

45. The cooked legume dough product of claim 44,
wherein cooking the legume dough pieces comprises at least one selected from the group consisting of:
baking the legume dough pieces; and
frying the legume dough pieces.

46. The cooked legume dough product of claim 44, wherein a protein content of the cooked legume dough product is in a range of 15 wt % to 40 wt %.

47. The cooked legume dough product of claim 44, wherein a content of indigestible sugars in the cooked legume dough product is at least 10 wt % less than a content of indigestible sugars in the fresh legumes.

48. A legume dough comprising:
cut legume particles having a moisture content of 50 wt % to 65 wt %, wherein a moisture content of the legume dough is in a range of 50 wt % to 70 wt %.

49. The legume dough of claim 48, wherein a protein content of the legume dough is in a range of 15 wt % to 40 wt %.

50. The legume dough of claim 48, wherein a content of indigestible sugars in the legume dough is at least 50 wt % less than a content of indigestible sugars in the fresh legumes.

51. The legume dough of claim 48, wherein the cut legume particles are formed from fresh legumes.

52. The legume dough of claim 48, wherein the legume dough is in the form of a substantially uniform sheet.

53. A cooked legume dough product comprising:
legume particles cut from fresh legumes; and
an additive,
wherein the protein content of the cooked legume dough product is in a range of 15 wt % to 40 wt %, and a content of indigestible sugars in the legume particles is at least 25 wt % less than a content of indigestible sugars in the fresh legumes.

54. The cooked legume dough product of claim 53,
wherein the additive comprises at least one selected from the group consisting of:
rice flour;
wheat flour;
corn flour; and
tapioca starch.

55. The cooked legume dough product of claim 53, wherein the cooked legume dough product comprises 20 wt % to 30 wt % of the additive.

56. The cooked legume dough product of claim 53, wherein the cooked legume dough product comprises 70 wt % to 80 wt % of the cut legume particles.

57. The method of claim 1, wherein the fresh legumes comprise at least one selected from the group consisting of:
whole legumes;
split legumes; and
legumes that have been reduced in size.

58. The legume dough of claim 41, wherein the fresh legumes comprise at least one selected from the group consisting of:
whole legumes;
split legumes; and
legumes that have been reduced in size.

59. The cooked legume dough product of claim 44, wherein the fresh legumes comprise at least one selected from the group consisting of:
whole legumes;
split legumes; and
legumes that have been reduced in size.

60. The method of claim 1, wherein:
the initial temperature is less than 100° F.;
the cooking temperature is in a range of 180° F. to 205° F.; and
the cooled mixture has a temperature of 170° F. or less.

61. The method of claim 1, wherein the cooked legumes have an average moisture content in a range of 50 wt % to 65 wt %.

62. The method of claim 1, wherein at least 90 wt % of the cooked legumes are whole.

63. The method of claim 1, wherein a content of indigestible sugars in the cooked legumes is at least 30 wt % less than a content of indigestible sugars in the fresh legumes.

64. The method of claim 1, wherein a content of indigestible sugars in the cooked legumes is at least 50 wt % less than a content of indigestible sugars in the fresh legumes.

65. The method of claim 39, wherein a content of indigestible sugars in the cooked legume dough product is at least 30 wt % less than a content of indigestible sugars in the fresh legumes.

66. The method of claim 39, wherein a content of indigestible sugars in the cooked legume dough product is at least 50 wt % less than a content of indigestible sugars in the fresh legumes.

67. The legume dough of claim 41, wherein:
the initial temperature is less than 100° F.;
the cooking temperature is in a range of 180° F. to 205° F.; and
the cooled mixture has a temperature of 170° F. or less.

68. The legume dough of claim 41, wherein the cooked legumes have an average moisture content in a range of 50 wt % to 65 wt %.

69. The legume dough of claim 41, wherein the cooked legumes have an average moisture content in a range of 60 wt % to 65 wt %.

70. The legume dough of claim 41, wherein the fresh legumes have a moisture content in a range of 8 wt % to 10 wt %;

71. The cooked legume dough product of claim 44, wherein:
the initial temperature is less than 100° F.;
the cooking temperature is in a range of 180° F. to 205° F.; and
the cooled mixture has a temperature of 170° F. or less.

72. The cooked legume dough product of claim 44, wherein the cooked legumes have an average moisture content in a range of 50 wt % to 65 wt %.

73. The cooked legume dough product of claim 44, wherein the cooked legumes have an average moisture content in a range of 60 wt % to 65 wt %.

74. The cooked legume dough product of claim 44, wherein the fresh legumes have a moisture content in a range of 8 wt % to 10 wt %;

75. The cooked legume dough product of claim 44, wherein a content of indigestible sugars in the cooked legume dough product is at least 30 wt % less than a content of indigestible sugars in the fresh legumes.

76. The cooked legume dough product of claim 44, wherein a content of indigestible sugars in the cooked legume dough product is at least 50 wt % less than a content of indigestible sugars in the fresh legumes.
